(19) United States
(12) Patent Application Publication
(10) Pub. No.: US 2024/0256111 A1
(43) Pub. Date: Aug. 1, 2024

(54) INFORMATION PROCESSING APPARATUS, NON-TRANSITORY COMPUTER READABLE MEDIUM, AND METHOD

(71) Applicant: FUJIFILM Business Innovation Corp., Tokyo (JP)

(72) Inventors: Takafumi HARUTA, Kanagawa (JP); Yuji ONOZAWA, Kanagawa (JP); Yohei MAKINO, Kanagawa (JP)

(73) Assignee: FUJIFILM Business Innovation Corp., Tokyo (JP)

(21) Appl. No.: 18/363,331

(22) Filed: Aug. 1, 2023

(30) Foreign Application Priority Data
Jan. 31, 2023 (JP) 2023-013560

(51) Int. Cl. G06F 3/04847; G06F 3/01; G06F 3/0487

(52) U.S. Cl. CPC G06F 3/04847; G06F 3/011; G06F 3/0487

(57) ABSTRACT

An information processing apparatus includes a processor configured to: obtain, after communication with a wearable terminal is established, biological information regarding a user who wears the wearable terminal from the wearable terminal; extract, as first setting information from plural pieces of setting information, where operation attributes of functions are set prior to execution of the functions, associated with biological information obtained when the plural pieces of setting information were created, a piece of setting information associated with same biological information as newly obtained biological information; and display the extracted first setting information on a display while giving priority to the first setting information over other pieces of setting information.

### CROSS-REFERENCE TO RELATED APPLICATIONS

This application is based on and claims priority under 35 USC 119 from Japanese Patent Application No. 2023-013560 filed Jan. 31, 2023.

### BACKGROUND

### (i) Technical Field

The present disclosure relates to an information processing apparatus, a non-transitory computer readable medium, and a method.

### (ii) Related Art

Japanese Unexamined Patent Application Publication No. 2015-150375 discloses a biological information collection system including a biological information measuring apparatus that measures biological information, a biological information collection apparatus that authenticates a measurement target using attribute information, that collects the biological information measured by the biological information measuring apparatus, and that associates the attribute information and the collected biological information with each other, and a management apparatus that obtains, from the biological information collection apparatus, the attribute information and the biological information associated with each other and that holds the biological information while associating the biological information with person information for identifying the measurement target.

Japanese Unexamined Patent Application Publication No. 2017-108316 discloses an image processing system including a terminal apparatus worn and used by a user and an image output apparatus that performs an output process, where an image is output in accordance with a command from the user. The terminal apparatus includes obtaining means for obtaining physical characteristics from the user. The terminal apparatus or the image output apparatus includes authentication means for performing an authentication process, where the user is authenticated on the basis of the physical characteristics obtained by the obtaining means, before the output process is performed. The image output apparatus includes output process means for performing the output process if the authentication means authenticates the user.

### SUMMARY

Because it is difficult to assign an administrator in an organization, such as a small or medium-sized company, for reasons of manpower, for example, user authentication is sometimes not performed when an information processing apparatus installed in the organization is used so that anyone in the organization can use the information processing apparatus.

When setting information set by different users in advance is displayed on such an information processing apparatus, the information processing apparatus displays the setting information in a mixed manner without classifying the setting information by user, since it is not known which user has set which piece of setting information. The users, therefore, need to search for a desired piece of setting information in the displayed setting information.

Aspects of non-limiting embodiments of the present disclosure relate to an information processing apparatus, a non-transitory computer readable medium, and a method capable of making it easier for a user to find a desired piece of setting information than when user authentication is not performed and setting information relating to functions created by different users is displayed as a list in a mixed manner.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to obtain, after communication with a wearable terminal is established; biological information regarding a user who wears the wearable terminal from the wearable terminal, extract, as first setting information from a plurality of pieces of setting information, where operation attributes of functions are set prior to execution of the functions, associated with biological information obtained when the plurality of pieces of setting information were created, a piece of setting information associated with same biological information as newly obtained biological information; and display the extracted first setting information on a display while giving priority to the first setting information over other pieces of setting information.

### BRIEF DESCRIPTION OF THE DRAWINGS

An exemplary embodiment of the present disclosure will be described in detail based on the following figures, wherein:

FIG. 1 is a diagram illustrating an example of the configuration of an image forming apparatus;

FIG. 2 is a diagram illustrating an example of a pairing table;

FIG. 3 is a diagram illustrating an example of a menu screen;

FIG. 4 is a diagram illustrating an example of a setting screen;

FIG. 5 is a diagram illustrating an example of an execution screen;

FIG. 6 is a diagram illustrating an example of a history table;

FIG. 7 illustrates an example of a history table in which only biological information is registered;

FIG. 8 illustrates an example of a history table in which only terminal information is registered;

FIG. 9 is a flowchart illustrating an example of a process for displaying setting information created by a user using biological information regarding the user;

FIG. 10 is a flowchart illustrating a process for displaying setting information created or used by a user using biological information regarding the user;

FIG. 11 is a flowchart illustrating an example of a process for displaying setting information created by a user using biological information regarding the user and terminal information regarding a wearable apparatus;

FIG. 12 is a flowchart illustrating an example of a process for displaying setting information created or used by a user using biological information regarding the user and terminal information regarding a wearable apparatus;

FIG. 13 is a diagram illustrating an example of a pairing table in which a user who owns plural wearable apparatuses is registered;

FIG. 14 is a diagram illustrating an example of a history table at a time when a user who owns plural wearable apparatuses has created and used setting information;

FIG. 15 is a flowchart illustrating an example of a process for displaying setting information created or used by a user who owns plural wearable apparatuses using biological information regarding the user and terminal information regarding the wearable apparatuses; and

FIG. 16 is a flowchart illustrating an example of a process for displaying setting information created or used by a user using biological information regarding the user, terminal information regarding a wearable apparatus, and additional information.

### DETAILED DESCRIPTION

An exemplary embodiment of the present disclosure will be described hereinafter with reference to the drawings. The same components and steps will be given the same reference numerals, and redundant description thereof is omitted.

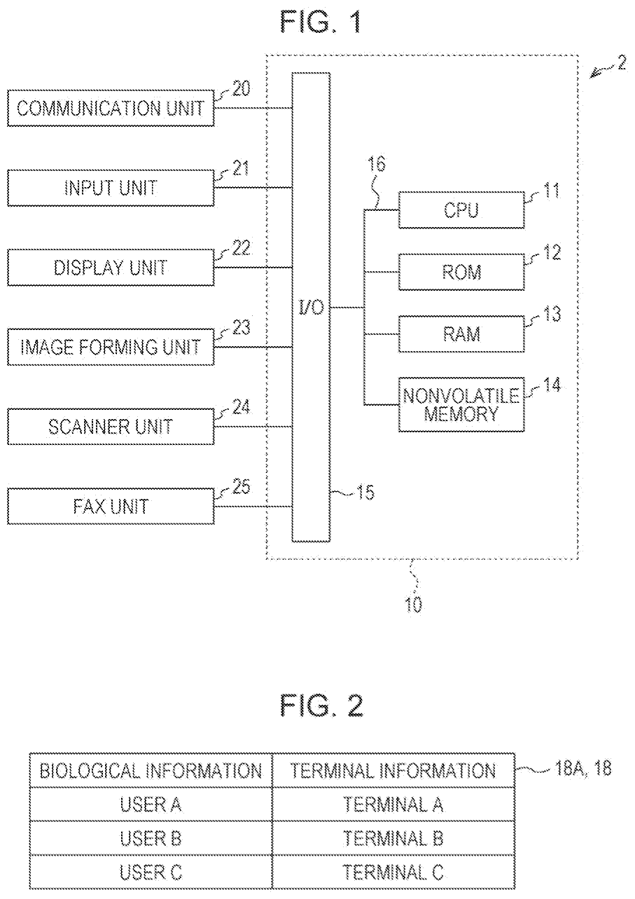

FIG. 1 is a diagram illustrating an example of the configuration of an information processing apparatus 2. The information processing apparatus 2 according to the present exemplary embodiment executes a selected function in accordance with setting information set by a user for each of setting items. A type of information processing apparatus 2 is not limited insofar as the information processing apparatus 2 receives an operation performed by the user through an operation medium and starts to execute a function, and an information processing apparatus of any type may be used.

The “setting items” herein refer to items that specify operation attributes of a function. The “setting information” refers to information where a setting value of an operation attribute set for each setting item and a name of a function for which the setting item is set are associated with each other. That is, the “setting information” is information where an operation attribute of a function is set prior to execution of the function. Each setting value may be set in any manner, and a value, text, a symbol, a figure, or an image, for example, may be used. The “operation medium” is a target operated by the user and refers to a user interface that allows the information processing apparatus 2 to receive operations performed by the user.

The information processing apparatus 2 according to the present exemplary embodiment will be described hereinafter using, as an example of the information processing apparatus 2, an image forming apparatus having at least one of plural functions including an image forming function for forming content of a specified file onto a recoding medium, a scanner function for optically reading content of a document, a copy function for forming content of a read document onto a recording medium as images, a fax function for communicating image data over a public network and forming received image data onto a recording medium as images, an email function for transmitting received data via email, and a file transfer protocol (FTP) function for transmitting received data using an FTP. The image forming apparatus, therefore, will be referred to as an “image forming apparatus 2” using the same reference numeral as for the information processing apparatus 2.

The above-described functions of the image forming apparatus 2 are examples, and the image forming apparatus 2 may have any functions.

The image forming apparatus 2 includes, for example, a computer 10. The computer 10 includes a central processing unit (CPU) 11, which is an example of a processor that executes the functions of the image forming apparatus 2, a read-only memory (ROM) 12 storing a program for processing information, the program causing the computer 10 to function as the image forming apparatus 2, a random-access memory (RAM) 13 used as a temporary work area of the CPU 11, a nonvolatile memory 14, and an input/output interface (I/O) 15. The CPU 11, the ROM 12, the RAM 13, the nonvolatile memory 14, and the I/O 15 are connected to one another through a bus 16.

The nonvolatile memory 14 is an example of a storage device that maintains information stored therein even when power is no longer supplied thereto and is a semiconductor memory, for example, but may be a hard disk, instead. Information that needs to be maintained even after the image forming apparatus 2 is turned off, such as setting information, is stored in the nonvolatile memory 14.

The nonvolatile memory 14 need not necessarily be incorporated into the computer 10, and may be a portable storage device removably attached to the computer 10, such as a memory card, instead.

A communication unit 20, an input unit 21, a display unit 22, an image forming unit 23, a scanner unit 24, and a fax unit 25 are connected to the I/O 15.

The communication unit 20 is connected to a communication network and includes a communication protocol for communicating data with external apparatuses connected to the communication network. When the email function or the FTP function of the image forming apparatus 2 is executed, data is communicated using the communication unit 20.

The communication unit 20 is also capable of short-range wireless communication. The short-range wireless communication is wireless communication whose communication range is short (e.g., 10 m or shorter). The short-range wireless communication may be, for example, radio-frequency identification (RFID), near-field communication (NFC), Zigbee (registered trademark), or Bluetooth (registered trademark). The communication unit 20 performs data communication with external apparatuses within the communication range using a known short-range wireless communication technique. As described later, the communication unit 20 performs data communication with wearable apparatuses worn by users. The wearable apparatuses worn by the users include, for example, information devices fixed to the users' bodies, such as information devices of a wristwatch or spectacle type, as well as information devices held by the users' hands and information devices in the users' clothes pockets or bags. That is, the wearable apparatuses are information devices that move as the users move.

The wearable apparatuses according to the present exemplary embodiment each have a function of obtaining, in response to a request from the image forming apparatus 2, biological information regarding a user who wears the wearable apparatus and transmitting the obtained biological information to the image forming apparatus 2 using the communication unit 20. The wearable apparatuses according to the present exemplary embodiment each have a function of transmitting, in response to a request from the image forming apparatus 2, terminal information regarding the wearable apparatus to the image forming apparatus 2 through the communication unit 20.

The biological information regarding a user is information obtained from the user's body. The biological information regarding a user includes various types of information such as a pulse wave, a pulse rate, fingerprints, blood pressure, vein patterns, and oxygen saturation, but the wearable apparatuses according to the present exemplary embodiment obtain, for example, pulse waves as the biological information.

The terminal information is information used to identify each wearable apparatus. The terminal apparatus regarding each wearable apparatus includes various types of information such as a serial number, a media access control (MAC) address, and an Internet protocol (IP) address, but the wearable apparatuses according to the present exemplary embodiment use the serial numbers thereof as the terminal information.

The input unit 21 is a device that receives commands from the users and that transmits the commands to the CPU 11 and is buttons, a touch panel, a pointing device, or the like. In an example, the image forming apparatus 2 includes at least a touch panel.

The display unit 22 is an example of a display device that displays, as images, information processed by the CPU 11 and is, for example, a liquid crystal display or an organic electroluminescent (EL) display. In an example, the touch panel, which is an example of the input unit 21, is provided over the display unit 22, and when a user presses the touch panel at a position at which an operation medium is displayed, a command associated with the operation medium is transmitted to the CPU 11. When a user presses an operation medium through the touch panel, the user “selects” the operation medium.

The image forming unit 23 forms received images onto a recording medium in accordance with instructions from the CPU 11. The image forming unit 23 may employ any method for forming an image, such as an electrophotographic method, an inkjet method, or an offset printing method. The image forming unit 23 is used to execute the image forming function, the copy function, and the fax function.

The scanner unit 24 optically reads, in accordance with instructions from the CPU 11, content of a document disposed on a platen glass, for example, and converts the read content of the document into image data. The scanner unit 24 is used to execute the scanner function, the copy function, and the fax function.

The fax unit 25 transmits image data obtained by the scanner unit 24, for example, to other fax apparatuses over a public network and receives image data from other fax apparatuses over the public network. The CPU 11 forms image data received over the public network onto a recording medium as images using the image forming unit 23.

The copy function is achieved when the CPU 11 forms image data obtained by the scanner unit 24 onto a recording medium using the image forming unit 23.

When the image forming apparatus 2 configured as illustrated in FIG. 1 detects, within the communication range of the short-range wireless communication performed by the communication unit 20, a wearable apparatus with which the image forming apparatus 2 has never performed data communication, the image forming apparatus 2 performs pairing, where information necessary for the data communication is exchanged, before establishing communication. The image forming apparatus 2 does not perform pairing again with a wearable apparatus paired therewith in the past, and immediately establishes communication and performs data communication.

The image forming apparatus 2 obtains biological information and terminal information from a wearable apparatus during pairing. The image forming apparatus 2 saves biological information and terminal information obtained during pairing to a pairing table 18A for the purpose of determining whether a detected wearable apparatus has been paired therewith in the past.

FIG. 2 is a diagram illustrating an example of the pairing table 18A. In the pairing table 18A, a combination of biological information and terminal information obtained by the image forming apparatus 2 from each wearable apparatus during pairing with the wearable apparatus is saved in units of biological information.

“User A” in a “biological information” field of the pairing table 18A indicates biological information regarding a user A. Similarly, “user B” indicates biological information regarding a user B, and “user C” indicates biological information regarding a user C. Biological information obtained from each wearable apparatus does not include information indicating a person to whom the biological information belongs. In order to clearly distinguish different pieces of biological information on the pairing table 18A, however, the biological information is indicated, for convenience of description, by names of users from whom the biological information has been obtained.

“Terminal A”, “terminal B”, and “terminal C” in a “terminal information” field of the pairing table 18A indicate terminal information obtained from wearable apparatuses during pairing. Combinations of biological information and terminal information saved in the pairing table 18A in units of biological information will be referred to as “saved information” hereinafter.

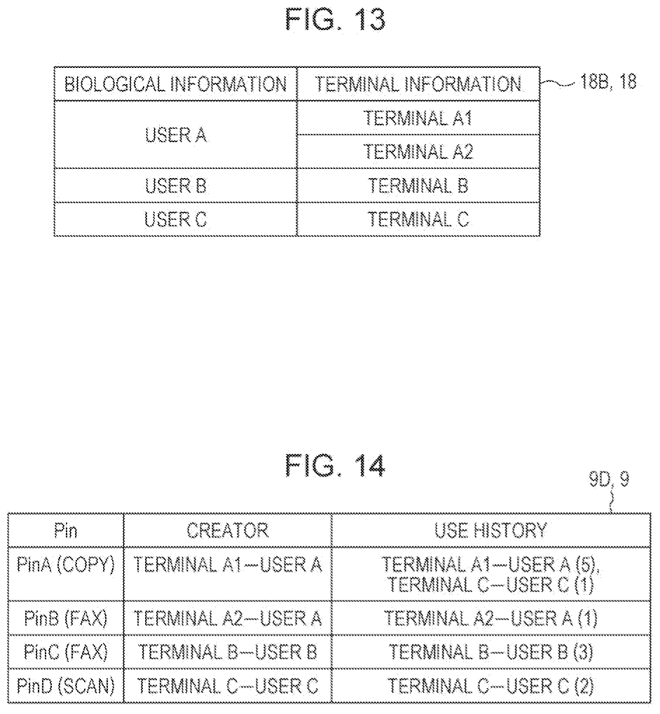

Although pairing tables (e.g., one illustrated in FIG. 13) other than the pairing table 18A will be referred to in the following description, each pairing table will be referred to as a “pairing table 18” when the pairing tables need not be distinguished from one another.

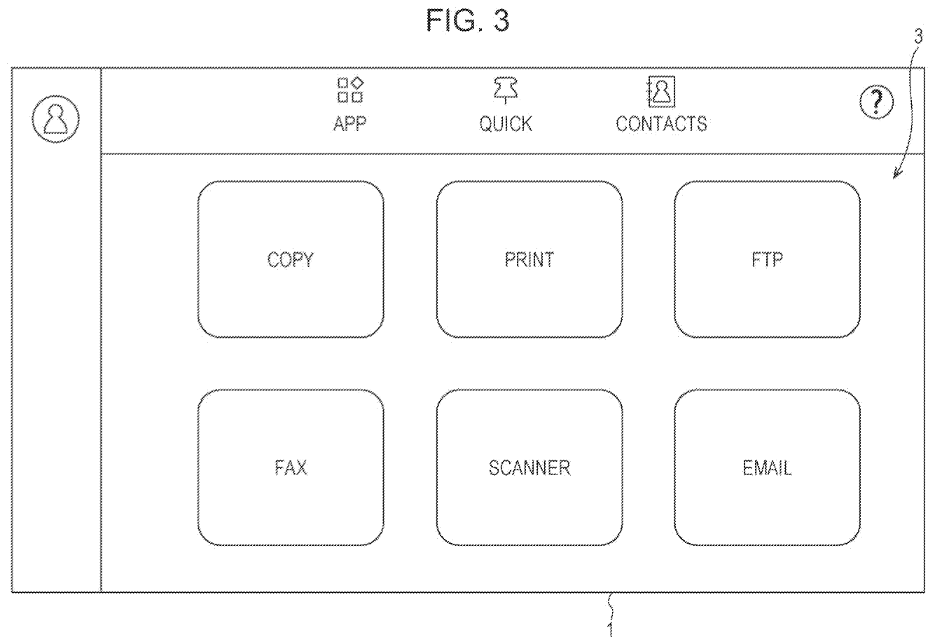

FIG. 3 is a diagram illustrating an example of a menu screen 1 displayed on the display unit 22 of the image forming apparatus 2. The menu screen 1 is an example of an initial screen displayed first on the display unit 22 when the image forming apparatus 2 is turned on.

The menu screen 1 includes menu buttons 3 for allowing a user to select a function to be executed. The menu buttons 3 include various buttons for executing the functions of the image forming apparatus 2. More specifically, the menu buttons 3 include a copy button for executing the copy function, a print button for executing the image forming function, a fax button for executing the fax function, a scanner button for executing the scanner function, an FTP button for executing the FTP function, and an email button for executing the email function.

When the user selects one of the menu buttons 3 corresponding to a certain function, the display unit 22 displays a setting screen 4 for the function associated with the selected menu button 3. The setting screen 4 includes various setting items for specifying operation attributes of the function.

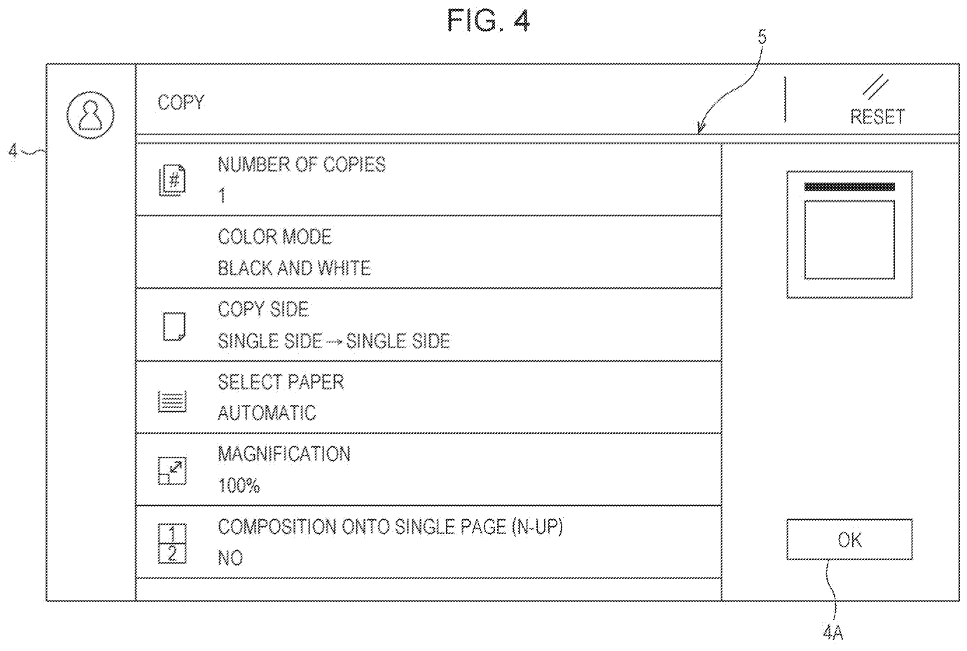

FIG. 4 is a diagram illustrating an example of a setting screen 4 displayed after the user selects the copy button among the menu buttons 3.

The setting screen 4 shows current setting values of setting items prepared for a corresponding function. When a display area of the setting screen 4 does not include all the setting items, the user can view all the setting items by scrolling the setting screen 4.

Setting items relating to the copy function include, for example, “number of copies”, “color mode” for specifying color of copied images, “copy side” for specifying a side of a recording medium used for copying, “select paper” for selecting a type of paper used for copying, “magnification” for setting a ratio of magnification in copying, and “N-up” for specifying the number of pages composed onto a single sheet.

The image forming apparatus 2 sets a predetermined initial value for each setting item as a setting value. The user changes, on the setting screen 4, the setting value of each setting item from the initial value to a desired value as necessary in order to perform copying as desired. Although the initial value is a factory default value preset by a manufacturer of the image forming apparatus 2, the user may change the initial value using the input unit 21. The image forming apparatus 2 may use a previously used setting value of each setting item as the initial value of the setting item.

When the user selects an OK button 4A to execute the copy function, the image forming apparatus 2 performs copying in accordance with the setting value set for each setting item of the copy function. Each time the image forming apparatus 2 executes a function, the image forming apparatus 2 stores combinations of a setting item and a setting value in the nonvolatile memory 14 as setting information.

Although the setting screen 4 and the creation of setting information at a time when the user has selected the copy function have been described above as an example, the image forming apparatus 2 also displays, when the user selects a function other than the copy function, a setting screen 4 corresponding to the selected function on the display unit 22 and receives setting of a setting value of each setting item. When the user selects a function other than the copy function, too, the image forming apparatus 2 stores setting information in the nonvolatile memory 14 each time the image forming apparatus 2 executes the function.

In order to enable the user to perform a function without making the same settings when the user uses the image forming apparatus 2 next time, the image forming apparatus 2 displays, on the display unit 22, a shortcut button for executing the function in accordance with stored setting information.

Next, shortcut buttons associated with various pieces of setting information will be described.

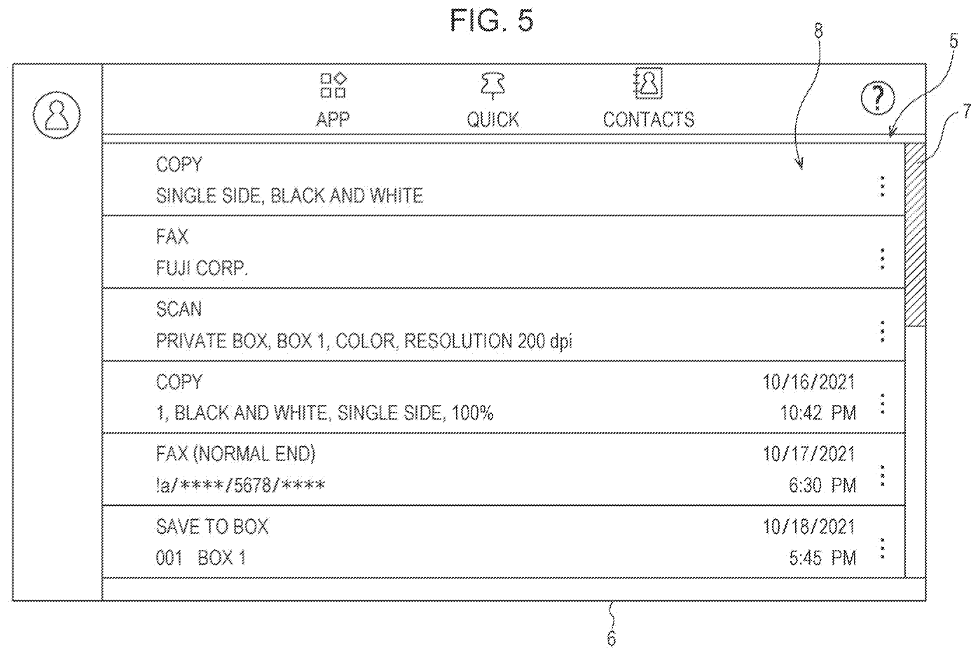

FIG. 5 is a diagram illustrating an example of an execution screen 6 for executing functions in accordance with the setting information stored in the nonvolatile memory 14. The execution screen 6 is displayed when, for example, the user presses a “quick” button displayed at a top of the menu screen 1 illustrated in FIG. 3. As described in detail later, shortcut buttons corresponding to certain pieces of setting information are displayed in the execution screen 6 while being given priority over shortcut buttons corresponding to other pieces of setting information.

In a list 5 in the execution screen 6, list items 8, which are examples of shortcut buttons associated with the setting information stored in the nonvolatile memory 14, are displayed. When the user selects one of the list items 8, a function associated with a piece of setting information associated with the selected list item 8 is executed in accordance with the piece of setting information using the same setting values as those stored in the piece of setting information. Names of functions of the setting information associated with the list items 8 and setting values of setting items are displayed in the list items 8.

By referring to the names of the functions and the setting values of the setting items displayed in the list items 8 and selecting a desired one of the list items 8 in the list 5 in the execution screen 6, the user can execute the same function in accordance with the same setting information as that set thereby for the function in the past, without setting the setting values of the setting items on the setting screen 4 illustrated in FIG. 4 each time the user executes the function.

When the user selects a list item 8 “copy, single side, black and white” in FIG. 5, for example, the image forming apparatus 2 executes the copy function with the copy side being a single side of a recording medium and the color mode being black and white.

When a display area of the list 5 does not include all the list items 8, the user can find a desired one of the list items 8 by scrolling the list 5 using a scroll bar 7.

Each piece of setting information will be denoted by “pin” hereinafter for convenience of description. In the example of the setting screen 4 illustrated in FIG. 4, the image forming apparatus 2 stores, in the nonvolatile memory 14, setting information actually used by the user by selecting the OK button 4A. There is a case, however, where the user desires to register in advance, to the execution screen 6, a list item 8 corresponding to setting information that the user will not use immediately but will be used frequently for a function. The image forming apparatus 2, therefore, may store, in the nonvolatile memory 14 as setting information, a combination of setting items and setting values set by the user without using the OK button 4A in the setting screen 4.

A combination of setting items and setting values set by the user on the setting screen 4 is an example of setting information created by the user. Setting information for a function executed by selecting the OK button 4A in the setting screen 4 and setting information for a function executed from the execution screen 6 by selecting one of the list items 8 are examples of setting information used by the user.

When a user creates and uses setting information, the image forming apparatus 2 generates a history table 9A storing the user (creator) who has created the setting information and a use history of the setting information in units of setting information.

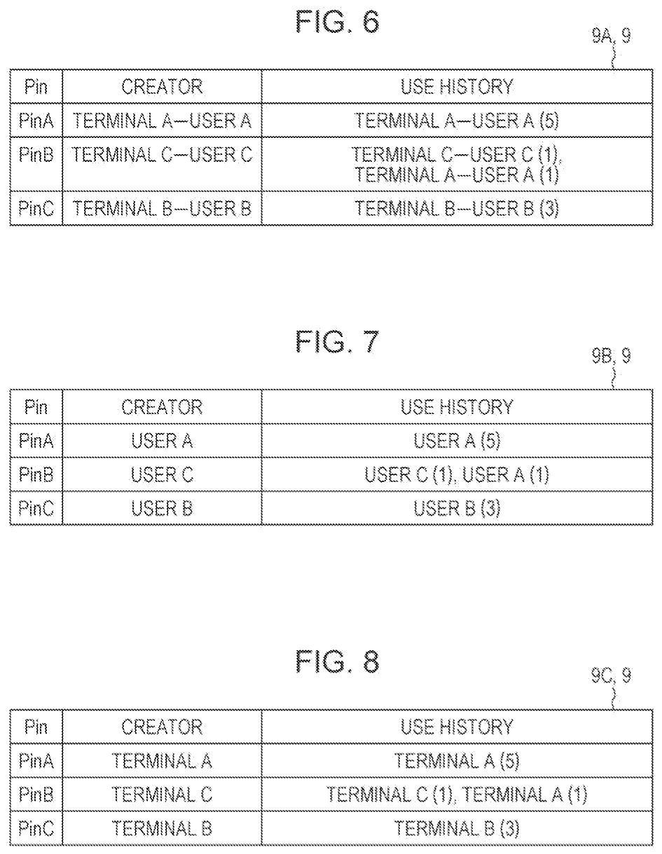

FIG. 6 is a diagram illustrating an example of the history table 9A. A “pin” field of the history table 9A stores names of setting information for identifying setting information generated by users. A “creator” field of the history table 9A stores information regarding the users who have created the setting information. A “use history” field of the history table 9A stores use statuses of the setting information.

The image forming apparatus 2, therefore, obtains, from a wearable apparatus, biological information and terminal information at a time when a user has created setting information on the setting screen 4 and stores the biological information and the terminal information in the “creator” field of the history table 9A. More specifically, each time a user creates setting information on the setting screen 4, the image forming apparatus 2 obtains, from a wearable apparatus worn by the user, biological information regarding the user and terminal information regarding the wearable apparatus and associates the biological information and the terminal information with the setting information as information indicating a creator of the setting information.

If the history table 9A stores the same setting information as that created by a user, however, the image forming apparatus 2 does not store biological information and terminal information obtained from a wearable apparatus in the “creator” field of the history table 9A.

The image forming apparatus 2 also obtains, from a wearable apparatus, biological information regarding a user and terminal information regarding the wearable apparatus at a time when the user has executed a function and stores the biological information and the terminal information in the “use history” of the history table 9A. More specifically, when a user selects the OK button 4A in the setting screen 4, or when a user selects one of the list items 8 in the execution screen 6, the image forming apparatus 2 obtains biological information and terminal information from a wearable apparatus and associates the biological information and the terminal information with setting information for an executed function as information indicating a use status of the setting information. In this case, the image forming apparatus 2 also stores the number of uses of the setting information for a combination of the biological information and the terminal information.

Users or the image forming apparatus 2 may set the names of setting information in the “pin” field of the history table 9A. The names of setting information and the setting information are associated with each other in one-to-one correspondence.

In the history table 9A illustrated in FIG. 6, it can be seen, for example, that a creator of setting information “PinA” is a user (the user A, more specifically) indicated by a combination of terminal information “terminal A” and biological information stored in the “creator” field. It can also be seen from a use history of the setting information “PinA” that the user (the user A, more specifically) indicated by the combination of the terminal information “terminal A” and biological information stored in the “use history” field has used the setting information five times.

Information where names of setting information, creators of the setting information, and use histories of the setting information are associated with one another in units of setting information will be referred to as “history information”.

As described above, biological information obtained from a wearable apparatus does not include information indicating a person to whom the biological information belongs. The biological information in the “creator” field and the “use history” field of the history table 9A, therefore, does not include information for identifying users, such as “user A”, and stores only biological information, but for convenience of description, the biological information is distinguished from one another using names of users from whom the biological information has been obtained.

Although an example where biological information and terminal information are obtained from a wearable apparatus and stored in the history table 9A when setting information is created or used has been described above, only biological information or terminal information may be obtained from a wearable apparatus and stored in the history table 9A, instead.

FIG. 7 illustrates an example of a history table 9B generated by obtaining only biological information from wearable apparatuses when setting information is created or used. The history table 9B shows the same history information as that stored in the history table 9A illustrated in FIG. 6 using only biological information.

FIG. 8, on the other hand, illustrates an example of a history table 9C generated by obtaining only terminal information from wearable apparatuses when setting information is created or used. The history table 9C shows the same history information as that stored in the history table 9A illustrated in FIG. 6 using only terminal information.

The image forming apparatus 2 may thus obtain only terminal information from wearable apparatuses, but may obtain biological information regarding users when possible, since biological information can be used to distinguish users more accurately than terminal information. Terminal information regarding wearable apparatuses need not necessarily be obtained insofar as biological information regarding users can be obtained.

Each history table will be referred to as a “history table 9” when history tables need not be distinguished from one another like the history tables 9A, 9B, and 9C.

### Display Process A

Next, a process for displaying setting information performed by the image forming apparatus 2 will be described,

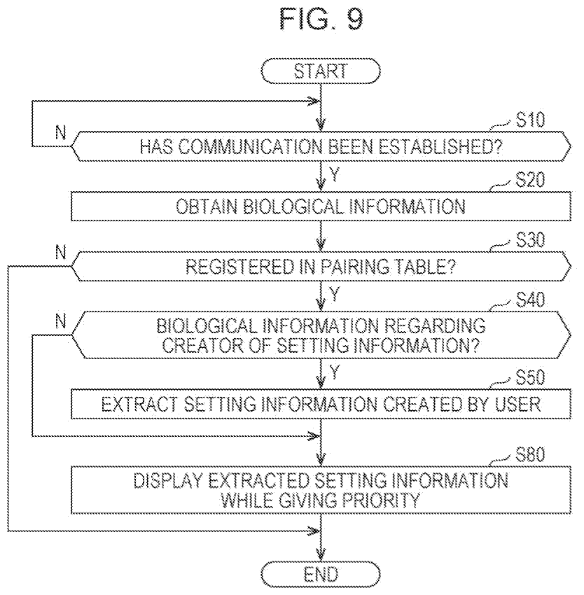

FIG. 9 is a flowchart illustrating an example of a process for displaying setting information performed by the CPU 11 of the image forming apparatus 2 when, for example, a user displays the execution screen 6 illustrated in FIG. 5 on the display unit 22 in order to execute a desired function using setting information created in advance.

The program for processing information, the program specifying the display process, is stored in advance in, for example, the ROM 12 of the image forming apparatus 2. The CPU 11 of the image forming apparatus 2 reads the program for processing information stored in the ROM 12 to perform the display process.

In step S10 in FIG. 9, the CPU 11 determines whether communication has been established with a wearable apparatus worn by the user who is to execute the desired function. If the wearable apparatus is outside the communication range of the short-range wireless communication performed by the communication unit 20, communication with the wearable apparatus is not established using the communication unit 20. The CPU 11, therefore, repeatedly makes the determination in step S10 and waits until communication with the wearable apparatus is established.

If the wearable apparatus is inside the communication range of the short-range wireless communication performed by the communication unit 20, on the other hand, the CPU 11 proceeds to step S20 in order to establish communication with the wearable apparatus using the communication unit 20.

In step S20, the CPU 11 requests biological information regarding the user from the wearable apparatus with which it has been confirmed as a result of the determination in step S10 that communication has been established and obtains the biological information regarding the user who wears the wearable apparatus, that is, the user who is to execute the desired function.

In step S30, the CPU 11 determines whether the biological information obtained in step S20 is registered in the “biological information” field of the pairing table 18. Since terminal information is not obtained from a wearable apparatus in the display process illustrated in FIG. 9, it is only required that at least biological information be registered in the pairing table 18, and terminal information need not necessarily be registered.

If the biological information obtained in step S20 is not registered in the “biological information” field of the pairing table 18, pairing has not been completed with the wearable apparatus worn by the user, and the display process illustrated in FIG. 9 ends. The display process illustrated in FIG. 9 may end, too, if biological information is not obtained from the wearable apparatus in step S20.

If the biological information obtained in step S20 is registered in the “biological information” field of the pairing table 18, on the other hand, the CPU 11 proceeds to step S40.

In step S40, the CPU 11 determines whether the biological information obtained in step S20 is stored in the “creator” field of the history table 9, that is, whether the biological information obtained in step S20 is biological information regarding a creator of a piece of setting information. Since whether obtained biological information is registered in the “creator” field of the history table 9 is determined in the display process illustrated in FIG. 9, it is only required that biological information regarding users be stored in the “creator” field and the “use history” field of the history table 9, and terminal information need not necessarily be stored. If the biological information obtained in step S20 is biological information regarding a creator of a piece of setting information, the CPU 11 proceeds to step S50.

In step S50, the CPU 11 refers to the history table 9, extracts the piece of setting information created by the user indicated by the biological information obtained in step S20, and proceeds to step S80. In other words, the CPU 11 extracts, from the setting information stored in the history table 9, setting information associated, in the “creator” field, with the same biological information as that obtained in step S20.

If there are plural pieces of setting information created by the user indicated by the biological information obtained in step S20, the CPU 11 extracts, from the setting information stored in the history table 9, all the pieces of setting information created by the user indicated by the biological information obtained in step S20.

Setting information created by a user who is to execute a function using the image forming apparatus 2, such as the setting information extracted in step S50, is an example of “first setting information”.

If determining in step S40 that the biological information obtained in step S20 is not biological information regarding a creator of any piece of setting information, on the other hand, the CPU 11 proceeds to step S80 without performing step S50.

In step S80, the CPU 11 displays the extracted piece of setting information on the display unit 22 while giving priority to the extracted piece of setting information over other pieces of setting information, and ends the display process illustrated in FIG. 9. More specifically, the CPU 11 displays a list item 8 corresponding to the piece of setting information extracted in step S50 in the list 5 of the execution screen 6 while giving priority to the list item 8 over list items 8 corresponding to the other pieces of setting information, and ends the display process illustrated in FIG. 9.

When an extracted piece of setting information is displayed while being given priority over other pieces of setting information, a user who is to execute a desired function can find the extracted piece of setting information more easily than the other pieces of setting information.

When the list item 8 corresponding to the extracted piece of setting information is displayed at a top of the list 5, the user can select the list item 8 corresponding to the extracted piece of piece of setting information without scrolling the list 5, which is an example of the case where an extracted piece of setting information is displayed while being given priority over other pieces of setting information.

When only the list item 8 corresponding to the extracted piece of setting information is displayed in the list 5 and the list items 8 corresponding to the other pieces of setting information are not displayed in the list 5, only the list item 8 corresponding to the extracted piece of setting information is selectable, which is another example of the case where an extracted piece of setting information is displayed while being given priority over other pieces of setting information.

When at least a background color, text size, a text color, or a font type of the list item 8 corresponding to the extracted piece of setting information is different from that of the list items 8 corresponding to the other pieces of setting information, the list item 8 corresponding to the extracted piece of setting information can be easily identified, which is another example of the case where an extracted piece of setting information is displayed while being given priority over other pieces of setting information.

When the list item 8 corresponding to the extracted piece of setting information is displayed larger than the list items 8 corresponding to the other pieces of setting information, the list item 8 corresponding to the extracted piece of setting information can be easily identified, which is another example of the case where an extracted piece of setting information is displayed while being given priority over other pieces of setting information.

If determining that the biological information obtained in step S20 is not biological information regarding a creator of any piece of setting information, on the other hand, the CPU 11 does not perform step S50. In this case, the CPU 11 displays list items 8 corresponding to the setting information in the list 5 of the execution screen 6 in, for example, predetermined order such as order of creation of the setting information or descending order of the number of uses of the setting information.

Displaying of list items 8 corresponding to setting information in the list 5 will be referred to as “display setting information” hereinafter.

With respect to the display process illustrated in FIG. 9, an example will be described where the CPU 11 refers to the pairing table 18A illustrated in FIG. 2 and the history table 9B illustrated in FIG. 7 when, for example, the user A who wears a wearable apparatus is to execute a desired function using the image forming apparatus 2. In this case, biological information regarding the user A is registered in the pairing table 18A, and PinA, which is setting information created by the user A, is stored in the history table 9B. The CPU 11, therefore, displays PinA while giving priority to PinA over PinB and PinC.

If determining in step S30 that the biological information obtained in step S20 is not registered in the “biological information” field of the pairing table 18, the display process illustrated in FIG. 9 ends since pairing has not been completed with the wearable apparatus worn by the user. The CPU 11, however, may perform pairing with the wearable apparatus worn by the user, proceed to step S40, and continue the display process illustrated in FIG. 9, instead.

The image forming apparatus 2 thus obtains biological information regarding a user who wears a wearable apparatus from the wearable apparatus, extracts, from plural pieces of setting information associated with biological information obtained when the plural pieces of setting information were created, a piece of setting information associated with the same biological information as the newly obtained biological information, and displays the extracted piece of setting information on the display unit 22 while giving priority to the extracted piece of setting information over other pieces of setting information. As a result, even in the case of an image forming apparatus 2 set up such that any user can use the image forming apparatus 2, not an image forming apparatus 2 set up such that a user needs to perform user authentication before executing a function and only users whose names are registered can use the image forming apparatus 2, an unidentified user who is to use the image forming apparatus 2 need not display setting information as a list in order of creation of the setting information, for example, and the user can easily find a desired one of plural pieces of setting information.

### Display Process B

Although an example where setting information created by a user who is to execute a desired function is displayed while being given priority over other pieces of setting information has been described with respect to the display process illustrated in FIG. 9, setting information that has been used by the user may also be displayed while being given priority over other pieces of setting information, in addition to the setting information created by the user.

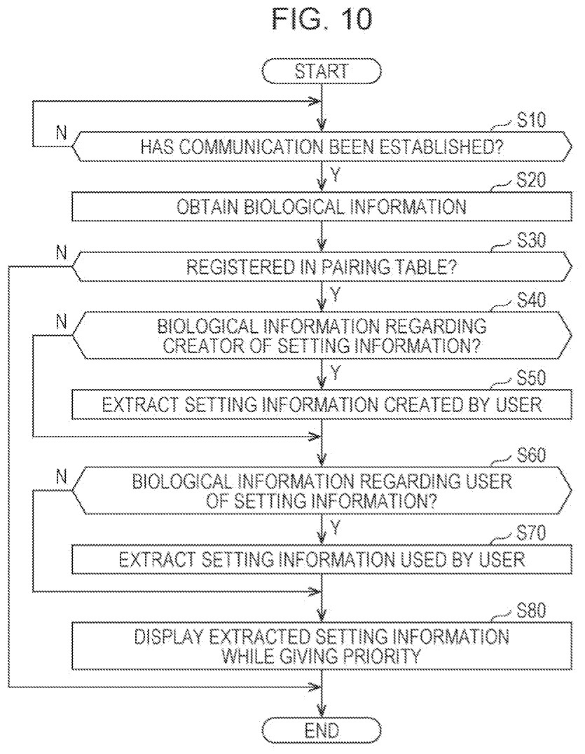

FIG. 10 is a flowchart illustrating an example of a process for displaying setting information performed by the CPU 11 of the image forming apparatus 2 when, for example, a user displays the execution screen 6 illustrated in FIG. 5 on the display unit 22 in order to execute a desired function using setting information created in advance.

The display process illustrated in FIG. 10 is different from that illustrated in FIG. 9 in that steps S60 and S70 are added, and other steps are the same as in the display process illustrated in FIG. 9. Steps S60 and S70, therefore, will be specifically described with respect to the display process illustrated in FIG. 10.

If determines in step S40 that the biological information obtained in step S20 is not biological information regarding a creator of any piece of setting information, or if extracting in step S50 the piece of setting information created by a user indicated by the biological information obtained in step S20 from the setting information stored in the history table 9, the CPU 11 performs step S60.

In step S60, the CPU 11 determines whether the biological information obtained in step S20 is biological information registered in the “use history” field of the history table 9, that is, biological information regarding a user who has used any piece of setting information registered in the image forming apparatus 2. If determining that the biological information obtained in step S20 is biological information regarding a user of any piece of setting information, the CPU 11 proceeds to step S70.

In step S70, the CPU 11 refers to the history table 9, extracts the piece of setting information used by the user indicated by the biological information obtained in step S20, and proceeds to step S80. In other words, the CPU 11 extracts, from the setting information stored in the history table 9, a piece of setting information associated, in the “use history” field, with the same biological information as that obtained in step S20.

If there are plural pieces of setting information used by the user indicated by the biological information obtained in step S20, the CPU 11 extracts, from the setting information stored in the history table 9, all the pieces of setting information used by the user indicated by the biological information obtained in step S20.

Setting information that has been used by a user who is to execute a function using the image forming apparatus 2, such as the piece of setting information extracted in step S70, is an example of “second setting information”.

Setting information used by a user may be setting information created by the user or setting information created by another user.

If determining in step S60 that the biological information obtained in step S20 is not biological information regarding a user of any piece of setting information, on the other hand, the CPU 11 proceeds to step S80 without performing step S70.

In step S80, the CPU 11 displays the piece of setting information extracted in steps S50 and S70, that is, the piece of setting information created by the user indicated by the biological information obtained in step S20 and the piece of setting information used by the user indicated by the biological information obtained in step S20, on the display unit 22 while giving priority to the piece of setting information over other pieces of setting information that have not been extracted, and ends the display process illustrated in FIG. 10.

If there are plural pieces of setting information used by the user, the CPU 11 sequentially displays the pieces of setting information in, for example, descending order of the number of uses.

A user creates setting information that suits his/her way of using the image forming apparatus 2 so that the user can comfortably use the image forming apparatus 2. When the CPU 11 has extracted both a piece of setting information created by a user and a piece of setting information used by the user as pieces of setting information to be displayed on the display unit 22 while being given priority over other pieces of setting information, the CPU 11 displays these pieces of setting information on the display unit 22 while giving priority to the piece of setting information created by the user over the piece of setting information used by the user.

Even in the case of setting information created by another user, however, the number of times that a user uses the setting information increases if the setting information suits the user's way of using the image forming apparatus 2. That is, the number of uses of setting information indicates how well the setting information suits a user's way of using the image forming apparatus 2. As the number of times that a user has used setting information increases, therefore, the setting information may be given priority over the setting information created by the user.

For this reason, if there is setting information that has been used a predetermined number of times or more, the CPU 11 may display the setting information on the display unit 22 while giving priority to the setting information over setting information created by the user. That is, the CPU 11 displays setting information that has been used by the user indicated by the biological information obtained in step S20 the predetermined number of times or more, setting information created by the user indicated by the biological information obtained in step S20, and setting information that has not been used by the user indicated by the biological information obtained in step S20 less than the predetermined number of times on the display unit 22 in this order while giving priority to these pieces of setting information over other pieces of setting information.

The predetermined number of times is stored in the nonvolatile memory 14 in advance, for example, and may be changed by each user.

With respect to the display process illustrated in FIG. 10, an example will be described where, for example, the CPU 11 refers to the pairing table 18A illustrated in FIG. 2 and the history table 9B illustrated in FIG. 7 when the user A who wears a wearable apparatus is to execute a desired function using the image forming apparatus 2. In this case, the biological information regarding the user A is registered in the pairing table 18A, and PinA, which is setting information created and used by the user A, and PinB, which is setting information created by a user other than the user A (the user C, more specifically) but used by the user A, are stored in the history table 9B. The CPU 11, therefore, displays PinA, PinB, and PinC while giving priority to PinA and PinB over PinC and to PinA, which has been created by the user A and used more than PinB, over PinB.

### Display Process C

With respect to the display process illustrated in FIG. 9, an example has been described where a piece of setting information created by a user who is to execute a desired function is displayed while being given priority over other pieces of setting information using biological information obtained from a wearable apparatus. The amount of information that can be used to extract setting information, however, increases when setting information to be given priority is extracted using biological information regarding a user and terminal information regarding a wearable apparatus worn by the user, and setting information that the user desires to use can be accurately displayed.

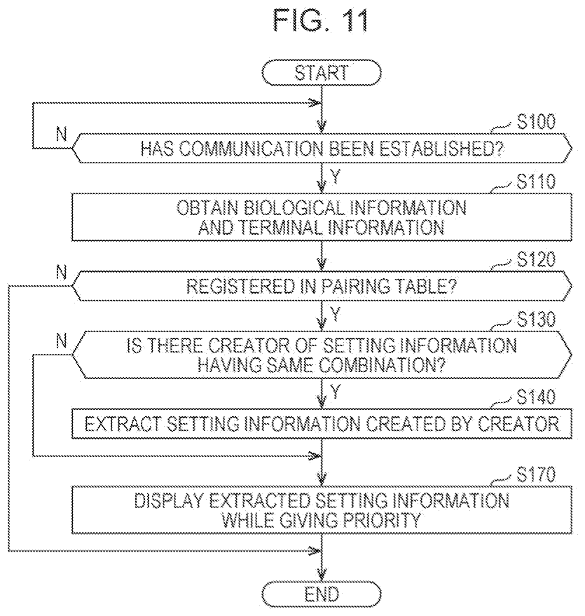

FIG. 11 is a flowchart illustrating an example of a process for displaying setting information performed by the CPU 11 of the image forming apparatus 2 when, for example, a user displays the execution screen 6 illustrated in FIG. 5 on the display unit 22 in order to execute a desired function using setting information created in advance.

In step S100 in FIG. 11, the CPU 11 determines, as in step S10 in FIG. 9, whether communication has been established with a wearable apparatus worn by the user who is to execute the desired function. If communication has not been established, the CPU 11 repeatedly makes the determination in step S100 and waits until communication is established with the wearable apparatus. If communication has been established with the wearable apparatus, on the other hand, the process proceeds to step S110.

In step S110, the CPU 11 requests biological information and terminal information from the wearable apparatus with which it has been confirmed as a result of the determination in step S100 that communication has been established and obtains biological information regarding the user who wears the wearable apparatus, that is, the user who is to execute the desired function, and terminal information regarding the wearable apparatus.

In step S120, the CPU 11 determines whether saved information regarding the same combination as that of the biological information and the terminal information obtained in step S110 is registered in the pairing table 18. Since the biological information regarding the user and the terminal information regarding the wearable apparatus are obtained from the wearable apparatus in the display process illustrated in FIG. 11, combinations of biological information regarding users and terminal information regarding wearable apparatuses obtained during pairing are also registered in the pairing table 18.

If the combination of the biological information and the terminal information obtained in step S110 is not registered in the pairing table 18, pairing with the wearable apparatus worn by the user has not been completed, and the display process illustrated in FIG. 11 ends. The display process illustrated in FIG. 11 may end, too, if the biological information and the terminal information, or the biological information, is not obtained from the wearable apparatus in step S110.

If the combination of the biological information and the terminal information obtained in step S110 is registered in the pairing table 18, on the other hand, the CPU 11 proceeds to step S130.

In step S130, the CPU 11 determines whether the same combination as that of the biological information and the terminal information obtained in step S110 is stored in the “creator” field of the history table 9, that is, whether the user indicated by the combination of the biological information and the terminal information obtained in step S110 is a creator of any piece of setting information. The “creator” field of the history table 9 referred to by the CPU 11 in the display process illustrated in FIG. 11 thus stores combinations of biological information regarding users and terminal information regarding wearable apparatuses obtained when the users created setting information.

If the user indicated by the combination of the biological information and the terminal information obtained in step S110 is a creator of any piece of setting information, the CPU 11 proceeds to step S140.

In step S140, the CPU 11 refers to the history table 9, extracts a piece of setting information created by the user indicated by the combination of the biological information and the terminal information obtained in step S110, and proceeds to step S170. In other words, the CPU 11 extracts, from the setting information stored in the history table 9, a piece of setting information associated, in the “creator” field, with the same combination as that of the biological information and the terminal information obtained in step S110.

If there are plural pieces of setting information created by the user indicated by the biological information and the terminal information obtained in step S110, the CPU 11 extracts, from the setting information stored in the history table 9, all the pieces of setting information created by the user indicated by the biological information and the terminal information obtained in step S110.

If determining in step S130 that the user indicated by the biological information and the terminal information obtained in step S110 is not a creator of any piece of setting information, on the other hand, the CPU 11 proceeds to step S170 without performing step S140.

In step S170, the CPU 11 displays the extracted piece of setting information on the display unit 22 while giving priority to the piece of setting information over other pieces of setting information, and ends the display process illustrated in FIG. 11. If no piece of setting information is extracted in step S170, the CPU 11 displays, on the display unit 22, the setting information in predetermined order such as order of creation of the setting information.

With respect to the display process illustrated in FIG. 11, an example will be described where, for example, the CPU 11 refers to the pairing table 18A illustrated in FIG. 2 and the history table 9A illustrated in FIG. 6 when the user A who wears the wearable apparatus whose terminal information is “terminal A” is to execute the desired function using the image forming apparatus 2. In this case, saved information regarding a combination of the biological information regarding the user A and the terminal information “terminal A” is registered in the pairing table 18A, and PinA, which is setting information created by the user A when the user A worn the wearable apparatus whose terminal information is “terminal A” is stored in the history table 9A. The CPU 11, therefore, gives priority to PinA over PinB and PinC.

In the determination in step S120, the terminal information obtained in step S110 might be registered in the pairing table 18 but the biological information obtained in step S110 might not be registered in the pairing table 18. If the user does not wear the wearable apparatus property during pairing, for example, the terminal information regarding the wearable apparatus is obtained but the biological information regarding the user is not obtained, and only the terminal information is registered in the pairing table 18.

If the biological information is not registered in the pairing table 18 for the terminal information obtained in step S110, the CPU 11 may determine that the combination of the biological information and the terminal information obtained in step S110 is not registered in the pairing table 18, and end the display process illustrated in FIG. 11. This is because plural users might share the same wearable apparatus.

Even when the biological information is not registered in the pairing table 18 for the terminal information obtained in step S110, however, the CPU 11 may determine that the combination of the biological information and the terminal information obtained in step S110 is registered in the pairing table 18 and perform step S130 and the later steps, instead, if the terminal information obtained in step S110 is registered in the pairing table 18. The CPU 11 thus performs processing in accordance with predetermined settings relating to the determination as to registration of pairing after biological information regarding a user is not obtained from a wearable apparatus.

### Display Process D

With respect to the display process illustrated in FIG. 11, an example has been described where a piece of setting information created by a user is extracted using biological information regarding the user who is to execute a desired function and terminal information regarding a wearable apparatus worn by the user and the piece of setting information created by the user is displayed while being given priority over other pieces of setting information. A piece of setting information that has been used by a user, however, may be extracted using biological information regarding the user and terminal information regarding a wearable apparatus worn by the user, in addition to a piece of setting information created by the user.

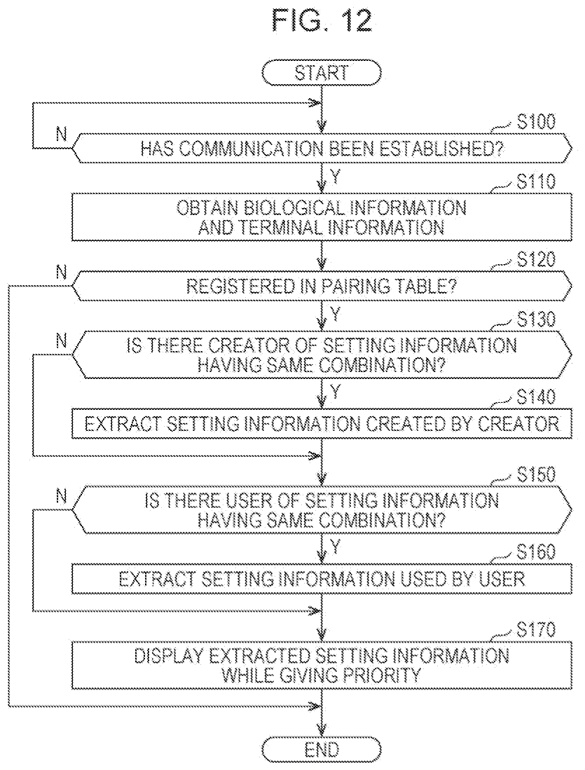

FIG. 12 is a flowchart illustrating an example of a process for displaying setting information performed by the CPU 11 of the image forming apparatus 2 when, for example, a user displays the execution screen 6 illustrated in FIG. 5 on the display unit 22 in order to execute a desired function using setting information created in advance by the user.

The display process illustrated in FIG. 12 is different from that illustrated in FIG. 11 in that steps S150 and S160 are added, and other steps are the same as in the display process illustrated in FIG. 11. Steps S150 and S160, therefore, will be specifically described with respect to the display process illustrated in FIG. 12.

If determining in step S130 that the user indicated by the combination of the biological information and the terminal information obtained in step S110 is not a creator of any piece of setting information, or if extracting in step S140 a piece of setting information created by a user indicated by the combination of the biological information and the terminal information obtained in step S110 from the setting information stored in the history table 9, the CPU 11 performs step S150.

In step S150, the CPU 11 determines whether the “use history” of the history table 9 stores the same combination as that of the biological information and the terminal information obtained in step S110, that is, whether the user indicated by the combination of the biological information and the terminal information obtained in step S110 is a user who has used any piece of setting information stored in the history table 9. If the user indicated by the combination of the biological information and the terminal information obtained in step S110 is a user of any piece of setting information, the CPU 11 proceeds to step S160.

In step S160, the CPU 11 refers to the history table 9, extracts a piece of setting information used by the user indicated by the combination of the biological information and the terminal information obtained in step S110, and proceeds to step S170. In other words, the CPU 11 extracts, from the setting information stored in the history table 9, a piece of setting information associated, in the “use history” field, with the same combination as that of the biological information and the terminal information obtained in step S110.

If there are plural pieces of setting information used by the user indicated by the combination of the biological information and the terminal information obtained in step S110, the CPU 11 extracts, from the setting information stored in the history table 9, all the pieces of setting information used by the user indicated by the combination of the biological information and the terminal information obtained in step S110.

If determining in step S150 that the user indicated by the combination of the biological information and the terminal information obtained in step S110 has never used any piece of setting information stored in the history table 9, on the other hand, the CPU 11 proceeds to step S170 without performing step S160.

In step S170, therefore, the piece of setting information that has been used by the user is also displayed in the execution screen 6 in addition to the piece of setting information created by the user who is to execute the desired function while being given priority over other pieces of setting information.

As described with respect to step S80 in FIG. 10, if extracting both the piece of setting information created by the user and the piece of setting information used by the user in step S170, the CPU 11 displays the pieces of setting information on the display unit 22 while giving priority to the piece of setting information created by the user to the piece of setting information used by the user. If there is a piece of setting information that has been used the predetermined times or more, the CPU 11 displays the piece of setting information while giving priority to the piece of setting information over the piece of setting information created by the user.

The predetermined number of times may be changed for each combination of biological information regarding a user and terminal information regarding a wearable apparatus.

With respect to the display process illustrated in FIG. 12, an example will be described where the CPU 11 refers to the pairing table 18A illustrated in FIG. 2 and the history table 9A illustrated in FIG. 6 when, for example, the user A who wears the wearable apparatus is to execute the desired function using the image forming apparatus 2. In this case, the combination as that of biological information and terminal information obtained from the wearable apparatus is stored in the pairing table 18A. The history table 9A stores the same combination as that of the biological information and the terminal information obtained from the wearable apparatus in the “creator” field and the “use history” field of PinA and the “use history” field of PinB. The CPU 11, therefore, gives priority to PinA and PinB over PinC, for example, and to PinA, which was created by the user A and has been used more than PinB, over PinB.

Although both a piece of setting information created by a user and a piece of setting information used by the user are extracted using a combination of biological information and terminal information obtained from a wearable apparatus in the display process illustrated in FIG. 12, either the piece of setting information created by the user or the piece of setting information used by the user may be extracted using the combination of the biological information and the terminal information obtained from the wearable apparatus, and the other piece of setting information may be extracted using only the biological information regarding the user.

### Display Process E

Some users own plural wearable apparatuses and, when using the image forming apparatus 2, might wear a wearable apparatus that has never been worn before. In the case of pairing where the image forming apparatus 2 obtains biological information regarding a user and terminal information regarding a wearable apparatus and registers the biological information and the terminal information to the pairing table 18, a user who has already been subjected to pairing using a wearable apparatus and whose biological information is already registered is newly subjected to pairing if the user wears another wearable apparatus having different terminal information, and an obtained combination of the biological information regarding the user and the terminal information regarding the other wearable apparatus is registered to the pairing table 18.

FIG. 13 is a diagram illustrating an example of a pairing table 18B in which a user who owns plural wearable apparatuses is registered. As illustrated in FIG. 13, when the user A owns a wearable apparatus whose terminal information is “terminal A1” and another wearable apparatus whose terminal information is “terminal A2”, for example, saved information where the terminal information “terminal A1” and “terminal A2” is associated with the biological information regarding the user A is registered to the pairing table 18.

When the image forming apparatus 2 obtains biological information regarding a user and terminal information regarding a wearable apparatus and stores a creation status and a use status of setting information in the history table 9 after the setting information is created or used, the image forming apparatus 2 stores, even when the biological information regarding the user remains the same as that already stored in the history table 9, an obtained combination of the biological information and the terminal information in the “creator” field and the “use history” field of the history table 9 if the terminal information regarding the wearable apparatus is different from that already stored in the history table 9.

FIG. 14 is a diagram illustrating an example of a history table 9D at a time when a user who owns plural wearable apparatuses has created and used setting information. As illustrated in FIG. 14, when the user A has created and used setting information while wearing the wearable apparatus whose terminal information is “terminal A1” and then the wearable apparatus whose terminal information is “terminal A2”, for example, a creation status and a use status of the setting information are stored in the history table 9 for each combination of the biological information regarding the user and terminal information regarding a wearable apparatus. The history table 9D illustrated in FIG. 14 stores, for example, a record indicating that the user A has used PinA, which is setting information created with the user A wearing the wearable apparatus whose terminal information is “terminal A1”, five times while wearing the wearable apparatus whose terminal information is “terminal A1”. The history table 9D also stores a record indicating that the user A has used PinB, which is setting information created with the user A wearing the wearable apparatus whose terminal information is “terminal A2”, once while wearing the wearable apparatus whose terminal information is “terminal A2”.

The example of the history table 9 illustrated in FIG. 14 stores records indicating functions of the image forming apparatus 2 to which setting information indicated by names of setting information stored in the “Pin” field relates. The CPU 11 may thus store, in the history table 9, function information indicating functions to which setting information relates while associating the function information with the setting information.

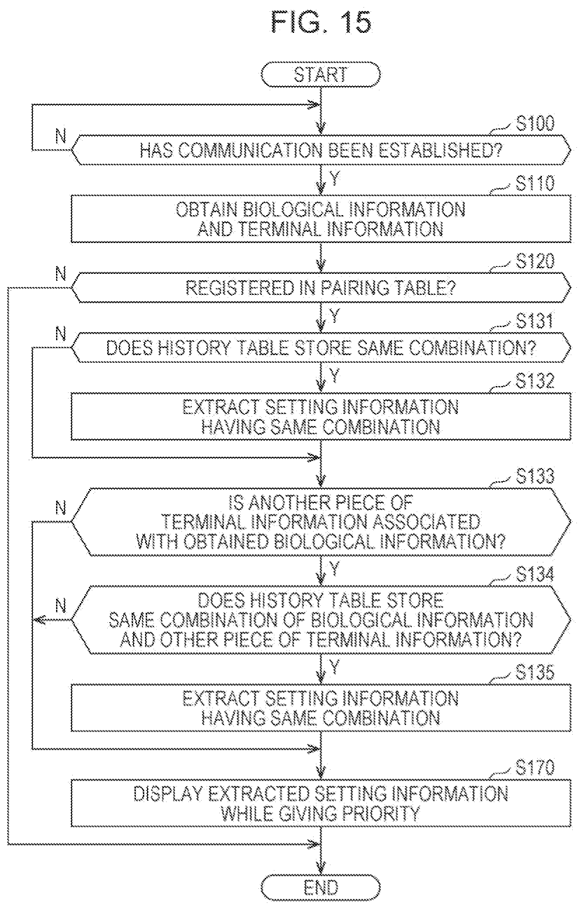

Next, an example of use of the image forming apparatus 2 by a user who owns plural wearable apparatuses will be described. FIG. 15 is a flowchart illustrating an example of a process for displaying setting information performed by the CPU 11 of the image forming apparatus 2 when, for example, a user who owns plural wearable apparatuses displays the execution screen 6 illustrated in FIG. 5 on the display unit 22 in order to execute a desired function using setting information created in advance.

The display process illustrated in FIG. 15 is different from that illustrated in FIG. 12 in that steps S130 to S160 are replaced by steps S131 to S135, and other steps are the same as in the display process illustrated in FIG. 12. Steps S131 to S135, therefore, will be specifically described with respect to the display process illustrated in FIG. 15.

If determining in step S120 that the combination of the biological information and the terminal information obtained in step S110 is registered in the pairing table 18, the CPU 11 performs step S131.

In step S131, the CPU 11 determines whether the combination of the biological information and the terminal information obtained in step S110 is stored in the “creator” field and/or the “use history” field of the history table 9. If the combination of the biological information and the terminal information obtained in step S110 is stored in the “creator” field and/or the “use history” field of the history table 9, the CPU 11 proceeds to step S132.

In step S132, the CPU 11 extracts, from the “creator” field and/or the “use history” field of the history table 9, all pieces of setting information including the same combination as that of the biological information and the terminal information obtained in step S110. As a result, setting information created and/or used by the user indicated by the combination of the biological information and the terminal information obtained in step S110 is extracted from the history table 9. The pieces of setting information extracted from the history table 9 in step S132 will be referred to as “third setting information”.

Next, the CPU 11 checks whether the user indicated by the combination of the biological information and the terminal information obtained in step S110 has ever created and/or used setting information while wearing another wearable apparatus having terminal information other than that obtained in step S110.

In step S133, therefore, the CPU 11 refers to the pairing table 18 and determines whether the biological information obtained in step S110 is associated with terminal information other than the terminal information obtained in step S110. If the biological information obtained in step S110 is associated with another piece of terminal information, the CPU 11 obtains the other piece of terminal information and proceeds to step S134.

In this case, a piece of setting information created or used by the user might exist for the user indicated by the biological information obtained in step S110 other than the piece of setting information extracted in step S132.

In step S134, therefore, the CPU 11 determines whether the “creator” field and/or the “use history” field of the history table 9 store the same combination as that of the biological information obtained in step S110 and the other piece of terminal information obtained after a result of the determination in step S133 becomes YES. If the “creator” field and/or the “use history” field of the history table 9 store the same combination as that of the biological information obtained in step S110 and the other piece of terminal information obtained after the result of the determination in step S133 becomes YES, the CPU 11 proceeds to step S135.

In this case, the “creator” field and/or the “use history” field of the history table 9 store the same combination as that of the biological information obtained in step S110 and the other piece of terminal information obtained after the result of step S133 becomes YES.

In step S135, therefore, the CPU 11 extracts, from the “creator” field and/or the “use history” field of the history table 9, all pieces of setting information including the same combination as that of the biological information obtained in step S110 and the other piece of terminal information obtained after the result of step S133 becomes YES and proceeds to step S170. The pieces of setting information extracted from the history table 9 in step S135 will be particularly referred to as “fourth setting information”.

If determining in step S133 that the biological information obtained in step S110 is not associated with terminal information other than the terminal information obtained in step S110, or if determining in step S134 that neither the “creator” field nor the “use history” field of the history table 9 stores the same combination as that of the biological information obtained in step S110 and the other piece of terminal information obtained after the result of step S133 becomes YES, on the other hand, the CPU 11 proceeds to step S170 without performing step S135.

As a result, in step S170, not only the third setting information but also the pieces of setting information created or used by the user, who is to execute the desired function, while wearing the wearable apparatus other than that is currently worn by the user, that is, the third setting information, are displayed in the execution screen 6 while being given priority over other pieces of setting information that have not been extracted.

A user is more likely to select the setting information created or used thereby in the past while wearing a currently wearing wearable apparatus in order to execute a desired function than the setting information created or used thereby while wearing a wearable apparatus other than the currently wearing one. When there are third setting information and fourth setting information, therefore, the CPU 11 may give priority to the third setting information over the fourth setting information.

With respect to the display process illustrated in FIG. 15, an example will be described where the CPU 11 refers to the pairing table 18B illustrated in FIG. 13 and the history table 9D illustrated in FIG. 14 when, for example, the user A who wears the wearable apparatus whose terminal information is “terminal A2” is to execute the desired function using the image forming apparatus 2. In this case, the same combination as that of the biological information and the terminal information obtained from the wearable apparatus is registered in the pairing table 18A. The “creator” field and the “use history” field of the history table 9D store, for PinB, the same combination as that of the biological information and the terminal information obtained from the wearable apparatus. In the pairing table 18B illustrated in FIG. 13, on the other hand, the terminal information “terminal A1” is also associated with the biological information regarding the user A obtained from the wearable apparatus in addition to “terminal A2”. The “creator” field and the “use history” field of the history table 9D store, for PinA, the same combination as that of the biological information obtained from the wearable apparatus and the terminal information “terminal A1”. The CPU 11, therefore, gives priority to PinA and PinB over PinC and PinD, for example, and to PinB, which is the third setting information, over PinA, which is the fourth setting information.

A correlation might be observed between a type of wearable apparatus worn by a user and a function to be used by the user. When a user owns a spectacle wearable apparatus having a function of scanning text in a gazing direction of the user and transmitting the text to the image forming apparatus 2 and desires to scan a billing address, transmit the billing address to the image forming apparatus 2, and automatically set a fax address, for example, the user is expected to wear the spectacle wearable apparatus, since the user can transmit the billing address to the image forming apparatus 2 using the spectacle wearable apparatus only by gazing the billing address. When a user owns a wristwatch wearable apparatus having a function of transmitting a file selected on a screen to the image forming apparatus 2 and desires to print content of the file on a recording medium, the user is expected to wear the wristwatch wearable apparatus, since the user can select, on the wristwatch wearable apparatus, a file to be printed without taking out an information device such as smartphone from a bag or the like.

The nonvolatile memory 14 stores in advance, therefore, information where terminal information regarding wearable apparatuses and functions likely to be used when the terminal information is obtained are associated with each other. When the history table 9D illustrated in FIG. 14 where function information is associated with setting information is used as the history table 9 referred to by the CPU 11 in this case, for example, the CPU 11 may display, among the pieces of setting information extracted in steps S132 and S135 in FIG. 15, pieces of setting information relating to a function associated with the obtained terminal information on the execution screen 6 in step S170 in FIG. 15 while giving priority to the pieces of setting information.

### Display Process F

The wearable apparatus is capable of obtaining information other than biological information regarding a user and terminal information regarding the wearable apparatus.

For example, a wearable apparatus including a camera obtains an image, a wearable apparatus including a microphone obtains a sound, and a wearable apparatus including a position sensor that measures a position like a global positioning system (GPS) sensor obtains positional information.

Because an image records a user's behavior and a surrounding condition, a sound records a user's words and actions, and positional information indicates a location of a user, the video, the sound, and the positional information are examples of information indicating a situation of a user who is to execute a desired function. Information that is other than biological information regarding a user or terminal information regarding a wearable apparatus, that indicates a user's situation, and that can be obtained using a function of each wearable apparatus will be referred to as “additional information”.

When the image forming apparatus 2 obtains additional information from a wearable apparatus, a user's situation is identified. When the user is to use a desired function of the image forming apparatus 2 and the image forming apparatus 2 extracts a piece of setting information that the user is likely to use from plural pieces of setting information also on the basis of additional information, the piece of setting information that the user is likely to use might be displayed in the execution screen 6 more accurately than when the image forming apparatus 2 extracts a piece of setting information using only biological information regarding the user and terminal information regarding the wearable apparatus.

An example where the image forming apparatus 2 obtains additional information along with biological information regarding a user and terminal information regarding a wearable apparatus from the wearable apparatus and displays a piece of setting information that the user is likely to use, therefore, will be described.

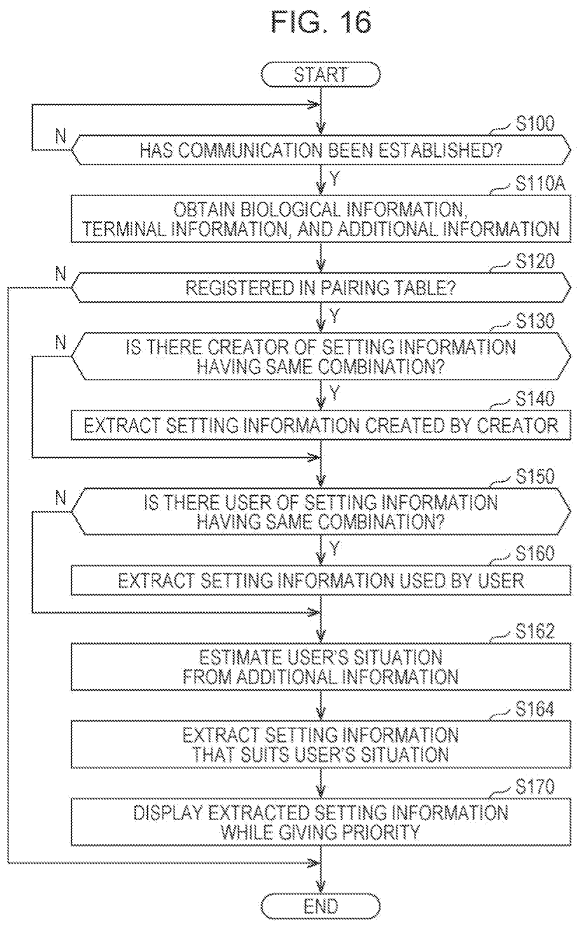

FIG. 16 is a flowchart illustrating an example of a process for displaying setting information performed by the CPU 11 of the image forming apparatus 2 when, for example, the user displays the execution screen 6 illustrated in FIG. 5 on the display unit 22 in order to execute a desired function using setting information created in advance.

The display process illustrated in FIG. 16 is different from that illustrated in FIG. 12 in that step S110 is replaced by step S110A and steps S162 and S164 are added between steps S160 and S170. Other steps are the same in the display process illustrated in FIG. 12. Steps S110A, S162, and S164, therefore, will be specifically described with respect to the display process illustrated in FIG. 16.

Step S110A is performed after communication is established with the wearable apparatus worn by the user.

In step S110A, the CPU 11 requests biological information, terminal information, and additional information from the wearable apparatus with which communication has been established and obtains the biological information regarding the user who is to execute the desired function, the terminal information regarding the wearable apparatus, and the additional information.

As described above, in steps S130 to S160 in FIG. 12, the CPU 11 extracts the pieces of setting information created or used by the user indicated by the combination of the biological information regarding the user and the terminal information regarding the wearable apparatus using the biological information and the terminal information.

In step S162, the CPU 11 analyzes the additional information obtained in step S110A and estimates the user's situation from the additional information.

If the obtained additional information is an image, for example, the CPU 11 estimates what is included in the video using a known method for analyzing an image. The video may be a moving image or a still image. if the obtained additional information is a sound, for example, the CPU 11 estimates words uttered by the user using a known method for analyzing a sound and an ambient sound around the user. If the obtained additional information is positional information, for example, the CPU 11 estimates a movement route of the user using chronological positional information.

When different types of additional information, such as an image and a sound, are obtained from the wearable apparatus, the CPU 11 may estimate the user's situation for each of the different types of additional information.

In step S164, the CPU 11 refers to the history table 9 and extracts a piece of setting information determined, on the basis of the user's situation estimated in step S162, to be likely to be used by the user.

More specifically, when an image where the user holds a universal serial bus (USB) memory is obtained as the additional information, the user is likely to execute a function using a file stored in the USB memory. The CPU 11, therefore, extracts, for example, a piece of setting information relating to the image forming function for forming content of the file stored in the USB memory onto a recording medium. When a sound including words “color copy” is obtained as the additional information, the user is likely to execute the copy function. The CPU 11, therefore, extracts, for example, a piece of setting information relating to the copy function. When positional information obtained from a department for digitizing a quotation as a result of optical character recognition (OCR) performed by the user on the quotation, the user is likely to execute the scanner function. The CPU 11, therefore, extracts a piece of setting information relating to the scanner function.

The CPU 11 extracts such a piece of setting information for the user's situation by referring to information where each situation is associated with a piece of setting information likely to be used by the user.

In step S170, the CPU 11 displays the extracted piece of setting information on the display unit 22 while giving priority to the extracted piece of setting information over other pieces of setting information, and ends the display process illustrated in FIG. 16. In step S170, therefore, not only the piece of setting information created or used by the user who is to execute the desired function but also the piece of setting information determined, on the basis of the user's situation indicated by the additional information, likely to be used are displayed on the execution screen 6 while being given priority over other pieces of setting information.

It is needless to say that the above-described extraction of a piece of setting information based on the additional information may be applied to the display processes illustrated in FIGS. 9 to 11 and 15.

Although a mode of the image forming apparatus 2 in the present disclosure has been described above using an exemplary embodiment, the disclosed mode of the image forming apparatus 2 is an example, and modes of the image forming apparatus 2 are not limited to that described in the exemplary embodiment. The exemplary embodiment may be modified or improved in various ways without deviating from the scope of the present disclosure, and the technical scope of the present disclosure includes such modifications and improvements. For example, order of processing in each of the display processes illustrated in FIGS. 9 to 12, 15, and 16 may be changed without deviating from the scope of the present disclosure.

In the exemplary embodiment, a mode where each display process is achieved by software has been described as an example. The same display processes as those illustrated in the flowcharts of FIGS. 9 to 12, 15, and 16, however, may be achieved by hardware, instead. In this case, each display process can be performed more rapidly than when the display process is achieved by software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Although an example where the ROM 12 stores the program for processing information has been described in the above exemplary embodiment, the program for processing information need not be stored in the ROM 12. The program for processing information in the present disclosure may be stored in a storage medium readable by the computer 10 and provided, instead. For example, the program for processing information may be stored in an optical disc such as a compact disc read-only memory (CD-ROM), a digital versatile disc read-only memory (DVD-ROM), or a Blu-ray disc and provided. The program for processing information may be stored in a portable semiconductor memory such as a USB memory or a memory card and provided. The ROM 12, the nonvolatile memory 14, the CD-ROM, the DVD-ROM, the Blu-ray disc, the USB memory, and the memory card are examples of a non-transitory storage medium.

Furthermore, the image forming apparatus 2, which is an example of the information processing apparatus, may download the program for processing information from an external apparatus connected to a communication network through the communication unit 20 and store the downloaded program for processing information in a storage device. In this case, the CPU 11 of the image forming apparatus 2 loads the program for processing information downloaded from the external apparatus and performs each display process.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing apparatus including:
a processor configured to:
   obtain, after communication with a wearable terminal is established, biological information regarding a user who wears the wearable terminal from the wearable terminal;
   extract, as first setting information from a plurality of pieces of setting information, where operation attributes of functions are set prior to execution of the functions, associated with biological information obtained when the plurality of pieces of setting information were created, a piece of setting information associated with same biological information as newly obtained biological information; and
   display the extracted first setting information on a display while giving priority to the first setting information over other pieces of setting information.
      (((2)))

The information processing apparatus according to (((1))),
in which each of the plurality of pieces of setting information is also associated with biological information obtained from the wearable terminal when the piece of setting information was used and a number of times, which is indicated by the obtained biological information, that each of users has used the piece of setting information,
in which the processor is configured to extract, as second setting information, a piece of setting information associated, as the biological information obtained when the piece of setting information was used, with same biological information as the newly obtained biological information, and
in which the processor is configured to display the extracted first setting information and second setting information on the display while giving priority to the first setting information and the second setting information over other pieces of the setting information.
   (((3)))

The information processing apparatus according to (((2))),
in which each of the plurality of pieces of setting information is also associated with terminal information for identifying the wearable terminal obtained from the wearable terminal when the piece of setting information was created, and
in which the processor is configured to extract, as the first setting information from the plurality of pieces of setting information, a piece of setting information associated, as the biological information and the terminal information obtained when the piece of setting information was created, with a same combination as a combination of the biological information and terminal information newly obtained from the wearable terminal.
   (((4)))

The information processing apparatus according to (((3))),
in which each of the plurality of pieces of setting information is also associated with terminal information obtained from the wearable terminal when the piece of setting information was used and a number of times that each user who wears the wearable terminal indicated by the terminal information has used the piece of setting information, and
in which the processor is configured to extract, as the second setting information from the plurality of pieces of setting information, a piece of setting information associated, as the biological information and the terminal information obtained when the piece of setting information was used, with a same combination as a combination of the biological information and terminal information newly obtained from the wearable terminal.
   (((5)))

The information processing apparatus according to (((4))),
in which the processor is configured to obtain, if saved information where combinations of terminal information for identifying the wearable terminal obtained from the wearable terminal when communication with the wearable terminal was established for a first time and biological information regarding a user who wears the wearable terminal are saved in units of biological information includes the newly obtained biological information, a piece of terminal information other than a piece of terminal information obtained along with the newly obtained biological information from terminal information associated in the saved information with the newly obtained biological information and extract, from the plurality of pieces of setting information, a piece of setting information associated with a combination of the newly obtained biological information and the other piece of terminal information, and
in which the processor is configured to display the extracted piece of setting information on the display while giving priority to the extracted piece of setting information, the first setting information, and the second setting information over other pieces of the setting information.
   (((6))

The information processing apparatus according to any one of (((2))) to (((5))),
in which the processor is configured to display the first setting information on the display while giving priority to the first setting information over the second setting information.
   (((7)))

The information processing apparatus according to (((6))),
in which the processor is configured to display, if a number of times that a user indicated by the newly obtained biological information has used the second setting information is larger than or equal to a predetermined number of times, the second setting information, which has been used the predetermined number of times or more on the display while giving priority to the second setting information over the first setting information.
   (((8)))

The information processing apparatus according to (((7))),
in which the processor is configured to also obtain, from the wearable terminal, additional information indicating a situation of a user who wears the wearable terminal,
in which the processor is configured to extract, from the pieces of setting information other than the first setting information and the second setting information, a piece of setting information associated in advance with the situation of the user indicated by the additional information, and
in which the processor is configured to display the piece of setting information extracted using the additional information on the display while giving the piece of setting information, the first setting information, and the second setting information over other pieces of the setting information.
   (((9)))

The information processing apparatus according to (((8))),
in which the additional information is at least an image, a sound, or positional information recorded by the wearable terminal.
   (((10)))

A program causing a computer to execute a process for processing information, the process including:
obtaining, after communication with a wearable terminal is established, biological information regarding a user who wears the wearable terminal from the wearable terminal;
extracting, as first setting information from a plurality of pieces of setting information, where operation attributes of functions are set prior to execution of the functions, associated with biological information obtained when the plurality of pieces of setting information were created, a piece of setting information associated with same biological information as newly obtained biological information; and
displaying the extracted first setting information on a display while giving priority to the first setting information over other pieces of setting information.

What is claimed is:

1. An information processing apparatus comprising:
a processor configured to:
obtain, after communication with a wearable terminal is established, biological information regarding a user who wears the wearable terminal from the wearable terminal;
extract, as first setting information from a plurality of pieces of setting information, where operation attributes of functions are set prior to execution of the functions, associated with biological information obtained when the plurality of pieces of setting information were created, a piece of setting information associated with same biological information as newly obtained biological information; and
display the extracted first setting information on a display while giving priority to the first setting information over other pieces of setting information.

2. The information processing apparatus according to claim 1,
wherein each of the plurality of pieces of setting information is also associated with biological information obtained from the wearable terminal when the piece of setting information was used and a number of times, which is indicated by the obtained biological information, that each of users has used the piece of setting information,
wherein the processor is configured to extract, as second setting information, a piece of setting information associated, as the biological information obtained when the piece of setting information was used, with same biological information as the newly obtained biological information, and
wherein the processor is configured to display the extracted first setting information and second setting information on the display while giving priority to the first setting information and the second setting information over other pieces of the setting information.

3. The information processing apparatus according to claim 2,
wherein each of the plurality of pieces of setting information is also associated with terminal information for identifying the wearable terminal obtained from the wearable terminal when the piece of setting information was created, and
wherein the processor is configured to extract, as the first setting information from the plurality of pieces of setting information, a piece of setting information associated, as the biological information and the terminal information obtained when the piece of setting information was created, with a same combination as a combination of the biological information and terminal information newly obtained from the wearable terminal.

4. The information processing apparatus according to claim 3,
wherein each of the plurality of pieces of setting information is also associated with terminal information obtained from the wearable terminal when the piece of setting information was used and a number of times that each user who wears the wearable terminal indicated by the terminal information has used the piece of setting information, and
wherein the processor is configured to extract, as the second setting information from the plurality of pieces of setting information, a piece of setting information associated, as the biological information and the terminal information obtained when the piece of setting information was used, with a same combination as a combination of the biological information and terminal information newly obtained from the wearable terminal.

5. The information processing apparatus according to claim 4,
wherein the processor is configured to obtain, if saved information where combinations of terminal information for identifying the wearable terminal obtained from the wearable terminal when communication with the wearable terminal was established for a first time and biological information regarding a user who wears the wearable terminal are saved in units of biological information includes the newly obtained biological information, a piece of terminal information other than a piece of terminal information obtained along with the newly obtained biological information from terminal information associated in the saved information with the newly obtained biological information and extract, from the plurality of pieces of setting information, a piece of setting information associated with a combination of the newly obtained biological information and the other piece of terminal information, and
wherein the processor is configured to display the extracted piece of setting information on the display while giving priority to the extracted piece of setting information, the first setting information, and the second setting information over other pieces of the setting information.

6. The information processing apparatus according to claim 2,
wherein the processor is configured to display the first setting information on the display while giving priority to the first setting information over the second setting information.

7. The information processing apparatus according to claim 3,
wherein the processor is configured to display the first setting information on the display while giving priority to the first setting information over the second setting information.

8. The information processing apparatus according to claim 4,
wherein the processor is configured to display the first setting information on the display while giving priority to the first setting information over the second setting information.

9. The information processing apparatus according to claim 5,
wherein the processor is configured to display the first setting information on the display while giving priority to the first setting information over the second setting information.

10. The information processing apparatus according to claim 6,
wherein the processor is configured to display, if a number of times that a user indicated by the newly obtained biological information has used the second setting information is larger than or equal to a predetermined number of times, the second setting information, which has been used the predetermined number of times or more on the display while giving priority to the second setting information over the first setting information.

11. The information processing apparatus according to claim 7,
wherein the processor is configured to display, if a number of times that a user indicated by the newly obtained biological information has used the second setting information is larger than or equal to a predetermined number of times, the second setting information, which has been used the predetermined number of times or more on the display while giving priority to the second setting information over the first setting information.

12. The information processing apparatus according to claim 8,
wherein the processor is configured to display, if a number of times that a user indicated by the newly obtained biological information has used the second setting information is larger than or equal to a predetermined number of times, the second setting information, which has been used the predetermined number of times or more on the display while giving priority to the second setting information over the first setting information.

13. The information processing apparatus according to claim 9,
wherein the processor is configured to display, if a number of times that a user indicated by the newly obtained biological information has used the second setting information is larger than or equal to a predetermined number of times, the second setting information, which has been used the predetermined number of times or more on the display while giving priority to the second setting information over the first setting information.

14. The information processing apparatus according to claim 10,
wherein the processor is configured to also obtain, from the wearable terminal, additional information indicating a situation of a user who wears the wearable terminal,
wherein the processor is configured to extract, from the pieces of setting information other than the first setting information and the second setting information, a piece of setting information associated in advance with the situation of the user indicated by the additional information, and
wherein the processor is configured to display the piece of setting information extracted using the additional information on the display while giving the piece of setting information, the first setting information, and the second setting information over other pieces of the setting information.

15. The information processing apparatus according to claim 11,
wherein the processor is configured to also obtain, from the wearable terminal, additional information indicating a situation of a user who wears the wearable terminal,
wherein the processor is configured to extract, from the pieces of setting information other than the first setting information and the second setting information, a piece of setting information associated in advance with the situation of the user indicated by the additional information, and
wherein the processor is configured to display the piece of setting information extracted using the additional information on the display while giving the piece of setting information, the first setting information, and the second setting information over other pieces of the setting information.

16. The information processing apparatus according to claim 12,
wherein the processor is configured to also obtain, from the wearable terminal, additional information indicating a situation of a user who wears the wearable terminal,
wherein the processor is configured to extract, from the pieces of setting information other than the first setting information and the second setting information, a piece of setting information associated in advance with the situation of the user indicated by the additional information, and
wherein the processor is configured to display the piece of setting information extracted using the additional information on the display while giving the piece of setting information, the first setting information, and the second setting information over other pieces of the setting information.

17. The information processing apparatus according to claim 13,
wherein the processor is configured to also obtain, from the wearable terminal, additional information indicating a situation of a user who wears the wearable terminal,
wherein the processor is configured to extract, from the pieces of setting information other than the first setting information and the second setting information, a piece of setting information associated in advance with the situation of the user indicated by the additional information, and
wherein the processor is configured to display the piece of setting information extracted using the additional information on the display while giving the piece of setting information, the first setting information, and the second setting information over other pieces of the setting information.

18. The information processing apparatus according to claim 14,
wherein the additional information is at least an image, a sound, or positional information recorded by the wearable terminal.

19. A non-transitory computer readable medium storing a program causing a computer to execute a process for processing information, the process comprising:
obtaining, after communication with a wearable terminal is established, biological information regarding a user who wears the wearable terminal from the wearable terminal;
extracting, as first setting information from a plurality of pieces of setting information, where operation attributes of functions are set prior to execution of the functions, associated with biological information obtained when the plurality of pieces of setting information were created, a piece of setting information associated with same biological information as newly obtained biological information; and
displaying the extracted first setting information on a display while giving priority to the first setting information over other pieces of setting information.

20. A method comprising:
obtaining, after communication with a wearable terminal is established, biological information regarding a user who wears the wearable terminal from the wearable terminal;
extracting, as first setting information from a plurality of pieces of setting information, where operation attributes of functions are set prior to execution of the functions, associated with biological information obtained when the plurality of pieces of setting information were created, a piece of setting information associated with same biological information as newly obtained biological information; and
displaying the extracted first setting information on a display while giving priority to the first setting information over other pieces of setting information.
